(19) United States
(12) Patent Application Publication
(10) Pub. No.: US 2022/0019961 A1
(43) Pub. Date: Jan. 20, 2022

(54) Autonomous Vehicle with Interchangeable, Multipurpose Carts and Related Systems and Methods

(71) Applicant: Dane Technologies, Inc., Maple Grove, MN (US)

(72) Inventor: Dan Johnson, Medina, MN (US)

(21) Appl. No.: 16/928,993

(22) Filed: Jul. 14, 2020

(51) Int. Cl. G06Q 10/08; G05D 1/02; B60P 1/02; G05D 1/00; H04W 4/80

(52) U.S. Cl. CPC G06Q 10/087; G05D 1/0225; G05D 2201/0216; G05D 1/0088; H04W 4/80; B60P 1/02

(57) ABSTRACT

Disclosed herein are various configurable, multifunctional area management carts that can be used to perform various functions in a large area such as a warehouse or retail building, along with various multifunctional area management systems that incorporate such carts to perform such functions. The cart can have a base comprising wheels operably coupled to the base, and a hitch operably coupled to the base, wherein the hitch is coupleable with the autonomous prime mover. The cart can also comprise an onboard processor associated with the base, wherein the onboard processor is in communication with the central processor, and an interface associated with the base, wherein the interface is in communication with the onboard processor. Certain alternative versions of the cart can also have at least one removable scaffold coupleable with the base, the at least one removable scaffold comprising at least one leg and at least one horizontal structure coupled to the at least one leg, and at least one area management instrument removably coupled to the at least one removable scaffold.

### FIELD

The various embodiments herein relate to autonomous vehicles (and attachable carts) for use in large spaces such as warehouses, retail spaces, and any other large space to provide management thereof.

### BACKGROUND OF THE INVENTION

It is frequently useful to track the disposition of inventory at a facility and further monitor the location and/or status of that inventory. For example, it is useful to track the presence and location of stored items in a storage facility or other similar location, including for audit purposes. In addition, the threat of viruses and resulting pandemics has increased the need to disinfect various types of facilities/buildings, including warehouses, retail buildings (such as grocery stores, for example), and the like. Further, another important task in such environments is stocking of inventory.

However, each of these tasks (including inventory tracking, disinfection, and inventory stocking) in large facilities/buildings can be difficult for various reasons.

For example, an audit of items stored or stocking of such items in such a building/facility can be an onerous task. Typically, items in a storage facility (such as, for example, goods in a warehouse or grocery store) are generally entered into an inventory list upon arrival at the facility. In an electronic system, the barcode on each item is scanned via RFID technology as it arrives and the information from the barcode is stored electronically. However, in this standard approach, the exact location of the item within the warehouse/retail space is not recorded. Matching records with the actual location of items can become exceedingly difficult due to the sheer volume of items in the facility. As such, if the item is placed in the wrong location or is moved to an unknown or incorrect location, it can be very difficult to locate or confirm the presence of such item.

In that context, a physical audit of the facility/building requires physically finding and identifying every item in the facility—a long and difficult process that can require hundreds, or even thousands, of manhours. As such, known systems and methods for tracking items and performing audits in a storage facility are costly and inefficient.

Further, both stocking of items (placement of the items in the appropriate place in a facility, such as a retail facility or warehouse, for example) and ongoing disinfection of a facility can be time consuming and require substantial costly manhours. In addition, performance of any of these functions in the face of standard traffic during working hours in an operating facility is very difficult, if not impossible, and concurrent performance of two or more of the functions is even more difficult.

There is a need in the art for improved devices, systems, and methods for area disinfection, stocking items, and/or tracking items in a building/facility.

### BRIEF SUMMARY

Discussed herein are various configurable, multifunctional area management carts that can be used to perform various functions in a large area such as a warehouse or retail building, along with various multifunctional area management systems that incorporate such carts to perform such functions.

In Example 1, a multifunctional area management system comprises an information management system comprising a central processor accessible on a wireless network, and a database in communication with the central processor, the database comprising area management information stored within the database. The system also comprises an autonomous prime mover and at least one configurable cart. The cart comprises a base comprising wheels operably coupled to the base, and a hitch operably coupled to the base, wherein the hitch is coupleable with the autonomous prime mover. The cart also comprises an onboard processor associated with the base, wherein the onboard processor is in communication with the central processor, an interface associated with the base, wherein the interface is in communication with the onboard processor, at least one removable scaffold coupleable with the base, the at least one removable scaffold comprising at least one leg and at least one horizontal structure coupled to the at least one leg, and at least one area management instrument removably coupled to the at least one removable scaffold.

Example 2 relates to the multifunctional area management system according to Example 1, wherein the at least one area management instrument comprises a camera; a temperature sensor, an RFID reader, a barcode reader, a UV light array; a location sensor, or a speed sensor.

Example 3 relates to the multifunctional area management system according to Example 2, wherein the camera comprises an object identification camera, a security camera, or a slip-and-fall danger detection camera.

Example 4 relates to the multifunctional area management system according to Example 1, wherein the at least one configurable cart is a inventory tracking cart, a disinfection cart, an item stocking cart, or a spill detection cart.

Example 5 relates to the multifunctional area management system according to Example 1, wherein the at least one leg comprises first and second legs, wherein the at least one horizontal structure comprises first and second horizontal structures coupled at a first end to the first leg and at a second end to a second leg.

Example 6 relates to the multifunctional area management system according to Example 5, further comprising at least one attachable bar coupled at a first end to the first horizontal structure and at a second end to the second horizontal structure.

Example 7 relates to the multifunctional area management system according to Example 6, wherein the at least one area management instrument is removably coupled to the attachable bar.

Example 8 relates to the multifunctional area management system according to Example 1, further comprising at least one attachment component associated with the base, wherein the at least one removable scaffold is coupleable with the base via the at least one attachment component.

Example 9 relates to the multifunctional area management system according to Example 8, wherein the at least one attachment component comprises a socket.

Example 10 relates to the multifunctional area management system according to Example 1, wherein the at least one removable scaffold is a disinfection scaffold comprising the at least one leg comprising first and second legs, the at least one horizontal structure comprising first and second horizontal structures, wherein each of the first and second horizontal structures is coupled at a first end to the first leg and at a second end to the second leg, and a UV light array removably coupled to the disinfection scaffold.

Example 11 relates to the multifunctional area management system according to Example 10, wherein the disinfection scaffold comprises first and second disinfection scaffolds.

Example 12 relates to the multifunctional area management system according to Example 1, wherein the at least one removable scaffold is an object tracking scaffold comprising the at least one leg being an extendable leg, and a collection apparatus removably coupled to the scaffold.

Example 13 relates to the multifunctional area management system according to Example 12, wherein the collection apparatus comprises at least one camera and at least one RFID reader.

In Example 14, a configurable, multifunctional area management cart comprises a base comprising wheels operably coupled to the base, and a hitch operably coupled to the base, wherein the hitch is coupleable with an autonomous prime mover. The system further comprises an onboard processor associated with the base, wherein the onboard processor is in communication with a central processor on a network, an interface associated with the base, wherein the interface is in communication with the onboard processor, and at least one removable scaffold coupleable with the base. The at least one removable scaffold comprises first and second legs, wherein at least one of the legs is removably coupleable with the base, and first and second horizontal structures, where each of the first and second horizontal structures is coupled at a first end to the first leg and at a second end to the second leg. The cart also comprises at least one area management instrument removably coupled to the at least one removable scaffold, wherein the at least one area management instrument comprises a camera; a temperature sensor, an RFID reader, a barcode reader, a UV light array; a location sensor, or a speed sensor.

Example 15 relates to the configurable, multifunctional area management cart according to Example 14, wherein the camera comprises an object identification camera, a security camera, or a slip-and-fall danger detection camera.

Example 16 relates to the configurable, multifunctional area management cart according to Example 14, further comprising at least one attachment component associated with the base, wherein the at least one removable scaffold is coupleable with the base via the at least one attachment component.

Example 17 relates to the configurable, multifunctional area management cart according to Example 14, wherein the at least one removable scaffold is a disinfection scaffold comprises first and second disinfection scaffolds, wherein each of the first and second disinfection scaffolds comprise at least one of the UV light array removably coupled thereto.

Example 18 relates to the configurable, multifunctional area management cart according to Example 14, wherein the at least one removable scaffold is an object tracking scaffold comprising the at least one leg being an extendable leg, and a collection apparatus removably coupled to the scaffold, wherein the collection apparatus comprises the camera and the RFID reader.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1A is a perspective view of a multifunctional autonomous vehicle, according to one embodiment.

FIG. 1B is a side view of the autonomous vehicle of FIG. 1A, according to one embodiment.

FIG. 10 is another side view of the autonomous vehicle of FIG. 1A, according to one embodiment.

FIG. 2 is a schematic view of a network for operation of a multifunctional autonomous vehicle in a large area such as a warehouse, according to one embodiment.

FIG. 3A is a perspective view of a multifunctional autonomous vehicle, according to another embodiment.

FIG. 3B is a side view of the autonomous vehicle of FIG. 3A, according to one embodiment.

FIG. 3C is another side view of the autonomous vehicle of FIG. 3A, according to one embodiment.

FIG. 4. is a perspective view of an autonomous vehicle in operation in a warehouse environment, according to one embodiment.

FIG. 5 is a schematic view of a network for operation of an autonomous vehicle with a multifunctional cart in a large area such as a warehouse, according to one embodiment.

FIG. 6A is a side view of a multifunctional autonomous vehicle, according to one embodiment.

FIG. 6B is a front view of the autonomous vehicle of FIG. 6A, according to one embodiment.

FIG. 6C is a top view of the autonomous vehicle of FIG. 6A, according to one embodiment.

FIG. 7A is a perspective view of a multifunctional cart, according to one embodiment.

FIG. 7B is a side view of the multifunctional cart of FIG. 7A, according to one embodiment.

FIG. 7C is a front view of the multifunctional cart of FIG. 7A, according to one embodiment.

FIG. 7D is a rear view of the multifunctional cart of FIG. 7A, according to one embodiment.

FIG. 8A is a side view of a multifunctional cart with a removable scaffold, according to another embodiment.

FIG. 8B is a rear view of the multifunctional cart of FIG. 8A, according to one embodiment.

FIG. 9A is a perspective view of a multifunctional cart with two removable scaffolds, according to a further embodiment.

FIG. 9B is a side view of the multifunctional cart of FIG. 9A, according to one embodiment.

FIG. 9C is a top view of the multifunctional cart of FIG. 9A, according to one embodiment.

### DETAILED DESCRIPTION

The various embodiments herein relate to a system that includes an autonomous vehicle and two or more attachable carts that each can perform additional tasks while being hauled or otherwise transported around the target area. One of the carts can be an inventory tracking cart, while another can be a disinfection cart, and another can be an inventory stocking cart. Further, the various embodiments herein can also include methods and systems for utilizing the autonomous vehicle and the attachable carts for disinfection of the target space, along with the comprehensive stocking, tracking, and/or auditing of items in a facility and/or, such as, for example, goods at a warehouse or in a grocery store or other retail space. In certain alternative embodiments, the autonomous vehicle has the tracking, transporting, and/or disinfection features built into the vehicle such that the attachable carts are unnecessary. In another alternative, one attachable cart can incorporate at least two of the stocking, tracking, and/or disinfection components/features thereon.

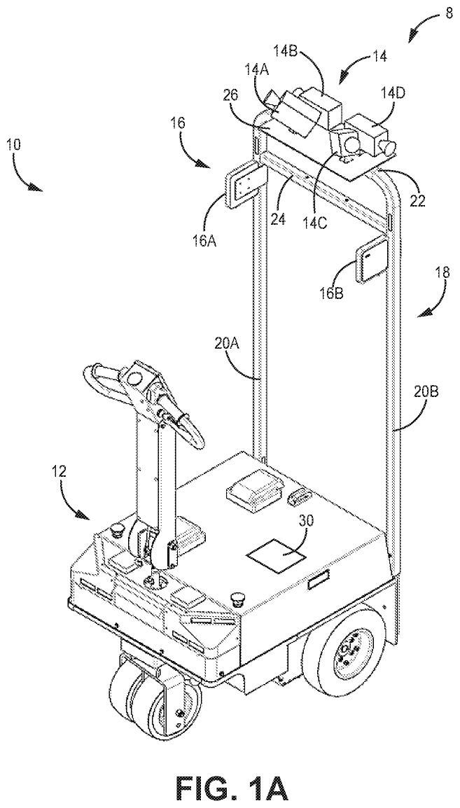

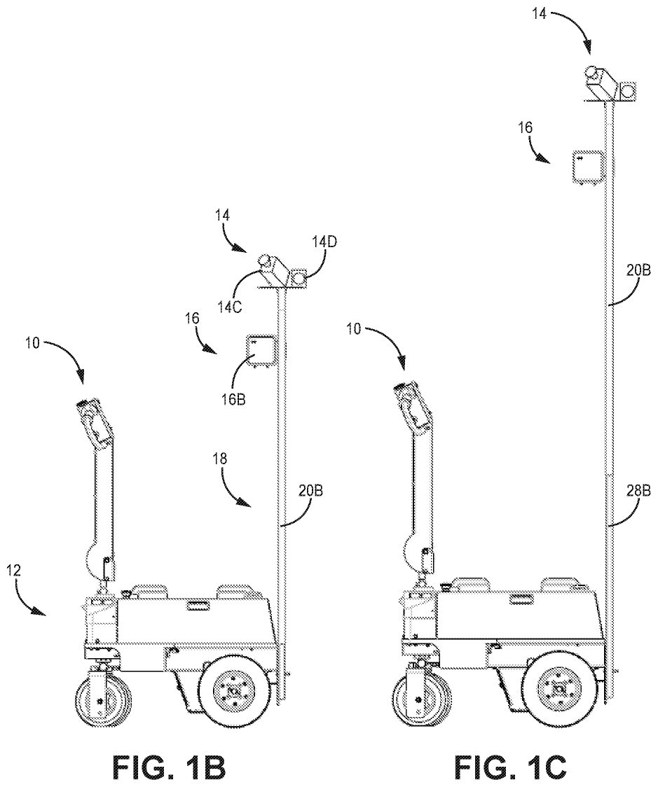

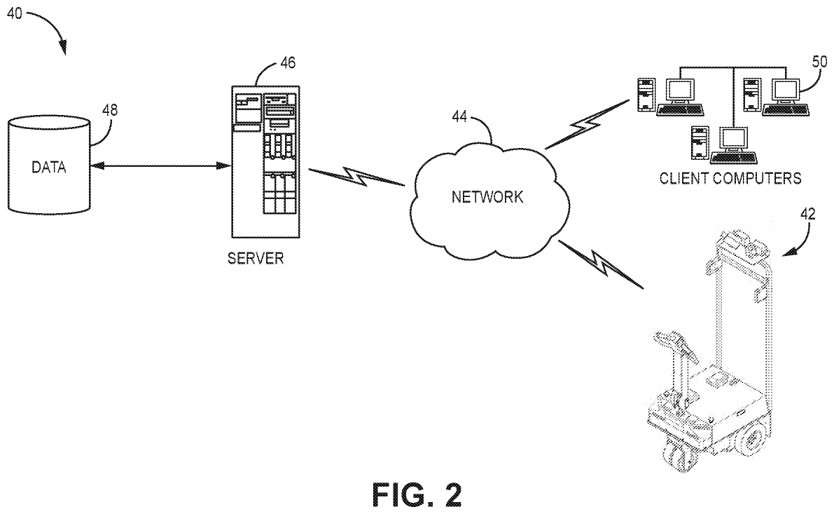

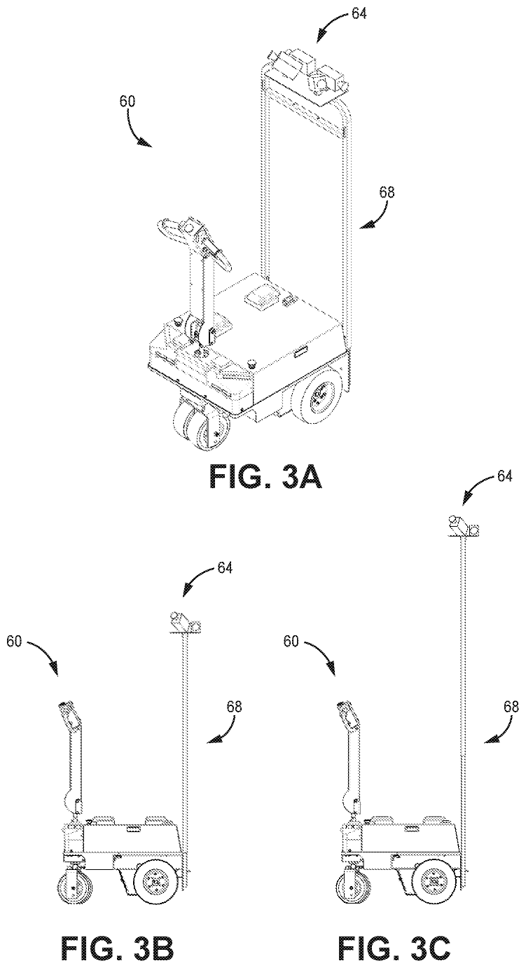

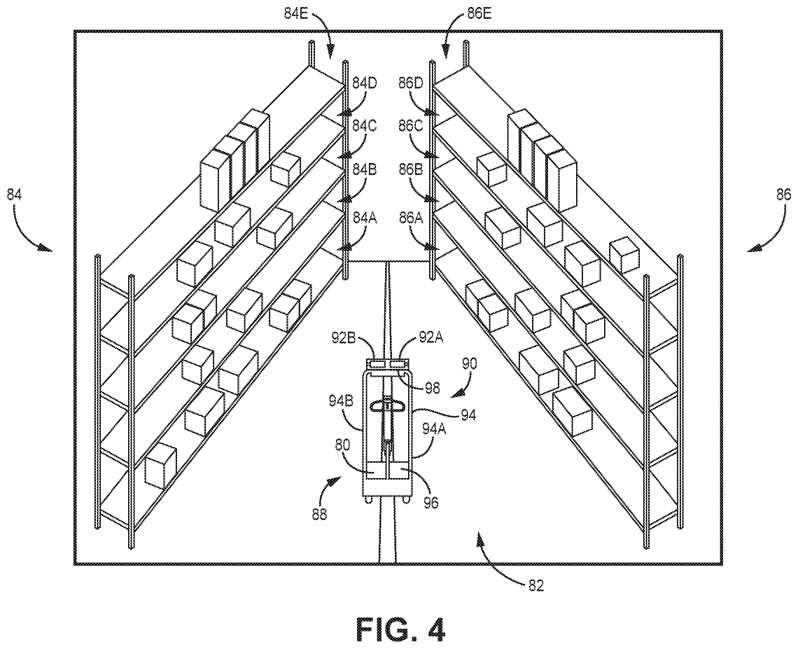

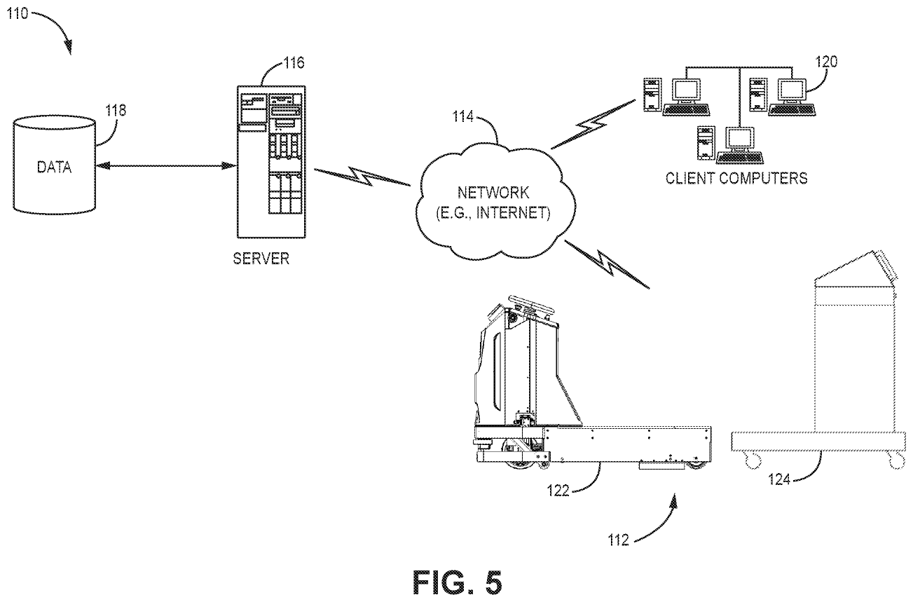

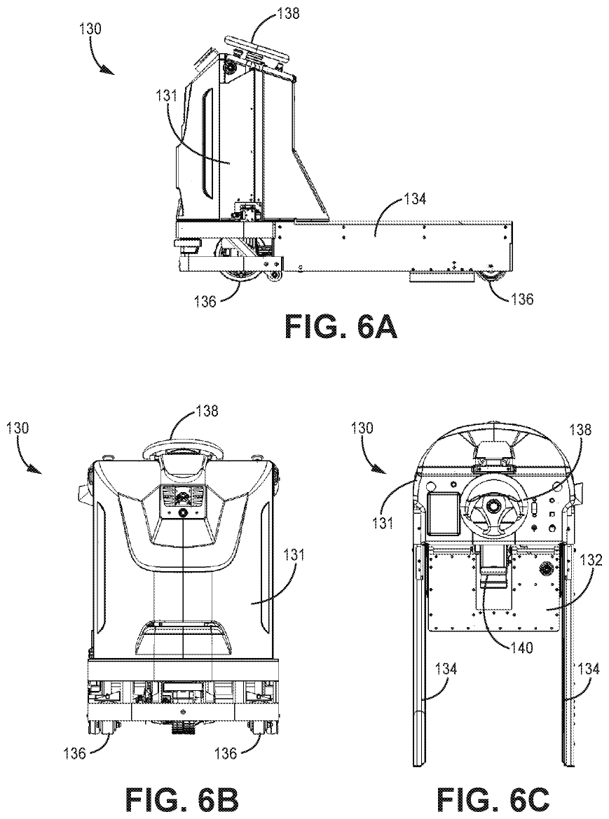

According to one embodiment as depicted in FIGS. 1A-1C, the vehicle 10 is a tracking vehicle 10 that is an autonomous transportation apparatus 12 having a collection apparatus 8 disposed thereon. In this implementation, the collection apparatus 8 has at least one digital camera 14 and at least one RFID reader 16 both attached to an extendable mast 18. The extendable mast 18 has two extendable rods 20A, 20B that are connected at a top portion via the upper crossbar 22 and lower crossbar 24. More specifically, the collection apparatus 8 has four digital cameras 14A, 14B, 14C, 14D and two RFID readers 16A, 16B attached to the mast 18. The cameras 14A-14C are disposed on a camera platform 26, which in turn is disposed on the upper crossbar 22. The RFID readers 16A, 16B are attached to the first and second rods 20A, 20B, respectively.

It is understood that the mast 18 is not limited to the specific two rod and two crossbar configuration in this specific example. Instead, the mast 18 can have any known configuration, including a single extendable rod or any type of extendable mechanism or component. Further, it is understood that the number of cameras 14 and the number of RFID readers 16 can be any number that is useful for capturing the target information, and that those cameras 14 and RFID readers 16 can be attached or otherwise coupled to the mast 18 in any known fashion or using any known mechanism.

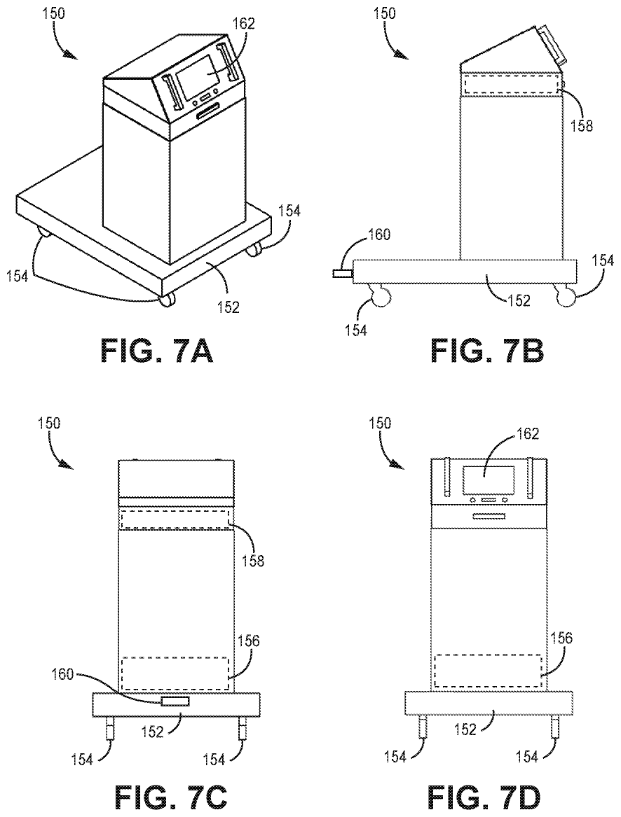

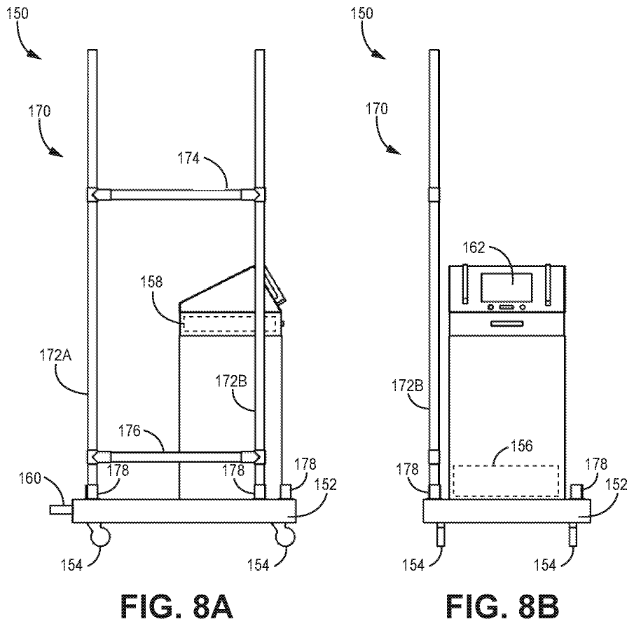

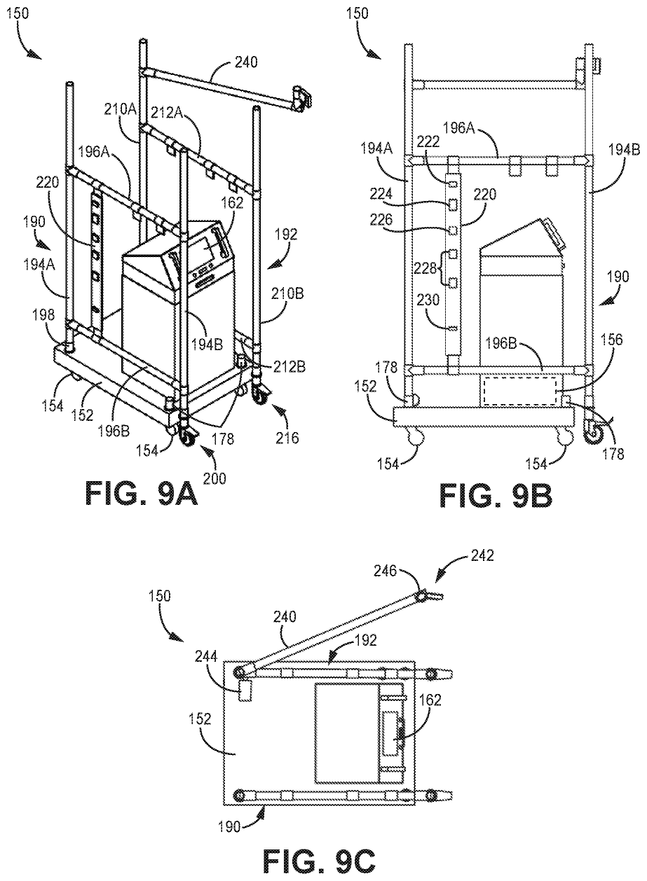

FIGS. 1B and 10 depict the two main positions of the extendable mast 18: the unextended or base position in FIG. 1B and its extended or deployed position in FIG. 10. In this specific embodiment, the first and second rods 20A, 20B are extendable outer rods 20A, 20B that are disposed over and extendable in relation to the first and second base or inner rods 28A, 28B (only inner rod 28B is depicted in FIG. 10, because inner rod 28A is disposed directly behind inner rod 28B when viewing the vehicle 10 from the side as shown). As such, as the first and second outer rods 20A, 20B move toward their extended position in which the mast 18 is raised as shown in FIG. 10, the inner rods 28A, 28B, which remain stationary and attached to the vehicle 12, become visible.

Each of the one or more cameras 14 in any of the vehicle embodiments herein can be any known digital camera that can capture a barcode or other information printed on an item. In the implementation as shown in FIG. 1A (and, the at least one camera 14 can include at least one camera (such as 14B) aimed out to one side of the vehicle 10 (in a direction parallel to the crossbar 22) and at least one camera (such as 14D) aimed toward the other, opposite side of the vehicle 10 (again, parallel to the crossbar 22). Alternatively, as shown in the specific exemplary embodiment of FIG. 1A, the at least one camera 14 can be four cameras 14A-14D, with two cameras 14A, 14B aimed generally toward one side of the vehicle and two cameras 14C, 14D aimed toward the other. In a further implementation, any vehicle embodiment disclosed or contemplated herein can have any number of cameras (one, two, three, four, five, six, seven, eight, or more) to operate as described herein.

The presence of at least two cameras (such as cameras 14B and 14D) aimed toward the sides of the vehicle 10 as shown allows for capturing information photographically on both sides of the vehicle 10. For example, in a warehouse environment in which the vehicle is positioned to advance down an aisle with two rows of shelving (one on each side of the aisle), two such cameras can capture images of any information provided on each item positioned on those shelves (or the absence of items), as will be described in further detail below. In certain embodiments (including, for example, the vehicle 10 of FIG. 1A), while two cameras 14B, 14D are disposed substantially parallel to the crossbar 22, two other cameras 14A, 14C are disposed at an angle such that the view each camera 14A, 14C captures is an area that is higher vertically in relation to the views captured by the parallel cameras 14B, 14D, thereby allowing the angled cameras 14A, 14C to capture images of items disposed at a greater height than the items captured by the parallel cameras 14A, 14C. And the extendable mast 18 allows for the cameras 14 to be raised to capture images of items disposed at a height that is higher than items disposed at or near the floor on which the device 10 is disposed, such as on shelves that are positioned above the ground- or floor-level shelves, as will also be described in further detail below.

As will also be described in further detail below, the vehicle 10 depicted in FIG. 1A (and any vehicle embodiment disclosed or contemplated herein) can also, in certain embodiments, have an on-board processor 30 coupled to the cameras 14. Further, the processor 30 can have software that processes the electronic images captured by the cameras 14 and enlarge or otherwise process the images to identify the information captured on the target items by the cameras. For example, in one embodiment, the software identifies any barcodes on any item captured by one of the cameras and captures the information in such barcodes, including identification of the item to which the barcode is attached and any other information provided therein. This process will be described in further detail below.

FIG. 2 depicts a schematic diagram of one embodiment of a network-based system 40 for tracking multiple items at a facility (or the absence thereof) and/or performing an audit of such items. As shown, the system 40 according to one embodiment can include a server 46 in communication with a tracking vehicle 42 according to any implementation herein and client computers 50 through a network 44. The at least one client computers 50 can be separately located at the facility site and/or at other locations, such as third party sites. “Client computers” as used herein shall mean any known type of processor or computer, and can also be referred to as site processors 50 or site computers 50. The system 40 allows for tracking and/or managing items at a facility, such as goods at a warehouse or any other known items at any type of facility that can benefit from tracking and/or an audit of such items. It is understood that the network 44 can be a wireless communication network 44 such as, for example, a Wi-Fi™ network 44, such that the tracking vehicle 42 (and any on-board processor on the vehicle 42 similar to the on-board processor 30 described above) is in communication with the server 46 via the wireless network 44. It is further understood that any of the components (such as the server 46, the vehicle 42, and the computers 50) can be coupled to any one or more of the other components via any other type of network 44, such as the Internet 44, and further than any connection can include multiple networks, such as both Wi-Fi™ and the Internet. In addition, it is understood that any component or feature of the system 40 can be operated via cloud computing and/or cloud storage.

As further shown in FIG. 2, according to one implementation, the server 46 is in communication with at least one database 48. It is understood that either or both the server 46 or the database 48 can be replaced with known cloud computing components. According to one embodiment, the database 48 contains information regarding each item, such as item identification, description, location in the facility, base cost, historical maintenance and service information (where appropriate), or any other kind of information relating to the item. Further, it is understood that the database 48 can also include any other known type of information relating to the item and/or the facility. For example, the information can include bays, shelves, or areas that are empty. That is, it identifies any spaces or areas in the facility that do not contain an item. Alternatively, various embodiments of the system described herein can have separate databases for various different kinds of information, including the information discussed herein.

It is understood that the server or central processor 46 (also referred to herein as an “system processor”) can be any computer or cloud-based server known to those skilled in the art. In one embodiment, the central processor 46 includes a website hosted in at least one or more computer servers. It is understood that any system disclosed herein may have one or more such server 46 and that each server may comprise a web server, a database server and/or application server, any of which may run on a variety of platforms. The server 46 can have any known configuration and have any known components, including, for example, a monitor or other screen device and an input device, such as a keyboard, a mouse, or a touch sensitive screen. Some non-limiting commercial examples of servers that could be used with various embodiments disclosed herein include Dell 2950, Sun Solaris, HP 9000 series, and IBM x3000 series.

In one implementation, the central processor 46 includes software programs or instructions that run on the server-side to process requests and responses from a client computer 50. These software programs or instructions send information to the client computer 50, perform calculation, compilation, and storage functions, transmit instructions to the client computer 50 or to one or more tracking vehicle 42, and generate reports. It is understood that any embodiment of the systems disclosed herein that provide for data collection, storage, tracking, and managing can be controlled using software associated with the system. It is further understood that the software can be any known software for use with the systems described herein to track and manage the item information as described herein.

In the system 40, generally, item data, including item tracking date, entered into the system 40 via the tracking vehicle 42 and/or a client computer or processor 50 is received by the server 46 and stored in the database 48. The database 48 serves as the inputs to and information storage for the system 40. According to one embodiment, the database 48 may be of any type generally known in the art, may be integral to the central processor 46, or may be accessible to the central processor 46 through a computer network or other suitable communication link. In one embodiment, the database 48 is comprised of a plurality of database servers, some of which are integral to the central processor 46, and some that are located remotely from the central processor 46. Some non-limiting commercial examples of databases that could be used with various embodiments disclosed herein include Oracle 9i, Oracle 10 g, Microsoft SQL Server, PostSQL, and Ingress.

The tracking vehicle 42 can be any embodiment of such a vehicle as disclosed or contemplated herein for collection of item information in the context of a facility in which the item is located. As used herein, “item” is intended to include any object of any kind that might be retained or otherwise located at a facility of any kind.

In certain embodiments of the system 40, the tracking vehicle 42 can have an on-board processor and software similar to the processor 30 and software described above. Alternatively, the information capturing and processing software as described elsewhere herein can be disposed on the server 46. In a further alternative, the software can be disposed on both the on-board processor (such as processor 30) and on the server 46.

FIGS. 3A-3C depicts another embodiment of a tracking vehicle 60. In this implementation, the tracking vehicle 60 is substantially similar to the vehicle 10 discussed above. That is, it is understood that each feature or component of the vehicle 60 is substantially the same or identical to the corresponding feature or component with respect to the vehicle 10, except as discussed herein. In this implementation, the collection apparatus 62 has at least one digital camera 64 attached to an extendable mast 68, but no RFID reader.

Returning to FIG. 1A (and corresponding FIG. 3A), according to one embodiment, the base vehicle 12 is an autonomous transportation apparatus 12 that can be operated autonomously or manually. According to one specific example, the base vehicle 12 is an apparatus that can transport carts or other types of trailers as disclosed in U.S. Pat. No. 9,010,771, which is hereby incorporated herein by reference in its entirety. In an alternative specific example, the vehicle 12 is an autonomous version of the apparatus of the '771 Patent. In a further alternative, the base vehicle 12 can be any known self-propelled or manually-propelled vehicle—and can either be autonomously or manually controlled—that can move about and operate in a facility of interest. Regardless of the vehicle 12, it is understood that the vehicle 12 has a collection apparatus (such as the apparatus 8 discussed above) attached thereto such that the vehicle is an inventory tracking vehicle.

In an alternative embodiment, the tracking apparatus can be a tracking trailer or cart as described elsewhere herein that is hitched or otherwise attached to a vehicle (such as any vehicle 12 disclosed or contemplated herein). The tracking trailer can be any wheeled apparatus to which the collection apparatus (such as apparatus 8 discussed above or any other such apparatus disclosed or contemplated herein) is coupled. As such, the tracking trailer can be attached to the vehicle 12 such that the trailer is pulled around the facility by the vehicle 12, thereby allowing the collection apparatus to collect information in the same fashion as any embodiment herein.

In use, the various system and device embodiments herein can be used to track items (or lack thereof) in a facility in the following fashion. One or more tracking vehicles (such as vehicle 10 or 42, for example) can be operated to travel through the facility and capture images of items and/or empty spaces located therein. For example, FIG. 4, according to one implementation, depicts a tracking vehicle 80 traveling down an aisle 82 in a facility with shelves 84, 86 of items on both sides of the aisle 82. More specifically, in this particular aisle, the shelving 84 on the left has five levels 84A, 84B, 84C, 84D, 84E as shown, including the floor level 84A, a first shelf 84B, a second shelf 84C, a third shelf 84D, and a fourth shelf 84E. Similarly, the shelving 86 on the right has the same five levels 86A, 86B, 86C, 86D, 86E. Alternatively, any type of shelving configuration with any known number of levels is contemplated.

The tracking vehicle 80 has similar or identical components and features as any of the vehicle embodiments herein. For purposes of this specific example, the vehicle 80 is an autonomous transportation apparatus 88 that is configured to push and/or pull carts (which can contain items) and has a collection apparatus 90 disposed thereon. In this implementation, the collection apparatus 90 has two digital cameras 92A, 92B attached to an extendable mast 94. The extendable mast 94 has two extendable rods 94A, 94B that are coupled at a lower portion of the rods 94A, 94B to the vehicle body 96 and connected to each other at a top portion via the crossbar 98.

In this embodiment, each of the two cameras 92A, 92B has a field of view that is large enough to capture two levels of the shelving 84, 86. As such, with the mast 94 in its base (or unextended) position, the first camera 92A can capture in its field of view the items on the floor level 86A and the first shelf 86B, while the second camera 92B can capture the items on the floor level 84A and the first shelf 84B. Once the vehicle 80 has travelled the entire length of the aisle 82 such that the cameras 92A, 92B have captured images of all the items and empty spaces on the floor level 84A, 86A and the first shelf 84B, 86B of each set of shelves 84, 86, the vehicle can travel the entire length of the aisle 82 a second time with the mast 94 extended such that the two cameras 92A, 92B can capture the next two levels of shelving. More specifically, on the second trip down the aisle 82, the mast 94 is extended such that the first camera 92A can capture in its field of view the items and empty spaces on the second shelf 86C and the third shelf 86D, while the second camera 92B can capture the items and empty spaces on the second shelf 84C and the third shelf 84D. And this continues, with the vehicle 80 making additional trips with the mast 94 further extended to the appropriate additional height each time such that the items and empty spaces on the higher shelves can be captured in images as well. And this process can continue for each aisle and/or set of shelves in the facility until all the items and empty spaces in the facility have been imaged. Alternatively, this process can be limited to a specific aisle, set of aisles, or section of the facility for some targeted tracking for any specific purpose.

In certain implementations, each camera 92A, 92B can identify a barcode (or other target summary of information) of an item in its field of view and “zoom in” to enlarge the barcode and capture the best, largest image of the barcode. That is, each camera 92A, 92B is configured to identify a barcode or other information summary of an item, in certain embodiments via software present in each camera 92A, 92B itself. Once the location of the barcode within the field of view is identified, the camera 92A, 92B is caused by the software to zoom in to the barcode itself, thereby increasing the size of the barcode with in the field of view while eliminating as many other things from the field of view as possible prior to capturing an image of the barcode. This same process is repeated for each item barcode identified within the wider field of view of the camera 92A, 92B. It is understood that any camera on any tracking vehicle embodiment disclose or contemplated herein can operate via the same process.

Similarly, according to any embodiment disclosed or contemplated herein, in those spaces (or bays) in which no item is positioned (an “empty space” or “empty bay,” each camera can capture an image of that empty space. Alternatively, each bay or space can have a barcode or other information summary disposed along a back wall or other location in the back of the space such that the “empty barcode” is only captured by the camera when the bay is empty. As such, the camera zooms in on the “empty” barcode via the same process described above, and the “empty barcode” information is collected such that the system can identify and track bays that don't contain any items.

As or after the images are captured, the electronic images are transported from the cameras 92 to the on-board processor (such as processor 30 discussed above) or transmitted via a wireless connection (such as the wireless connection in FIG. 2) and a network (such as the network 44) to a server (such as server 46). At the on-board processor or the server, the software described above is used to process the image and identify information captured about each item. In certain specific embodiments, the images are processed to enlarge and read the barcodes on each item, and then storing the information from the barcode. In certain embodiments, the location of the tracking vehicle 80 (and thus the location of the barcode) is linked or otherwise associated with the image, thereby providing location information regarding that barcode (and thus the item to which the barcode is attached). Other information about the item can also be included on the barcode and thus stored by the processor or server. In one embodiment, the information is stored in a database (such as database 48 in FIG. 2). In a further alternative, the electronic images are stored in the cameras 92 or transmitted to an on-board database (not shown) on the vehicle 80 and stored for later transmission. According to yet another alternative, the software in the on-board processor (such as processor 30) identifies the barcode and transmits solely the barcode data and the location via the wireless connection while storing the full image in the on-board database for subsequent physical transfer and analytics. Once the vehicle 80 returns to its home base, storage bay, or other home location within the facility, a physical connection can be coupled to the vehicle 80 and the electronic images can be transported via the physical connection to the server (such as server 46 of FIG. 2) or other similar location on a system (such as system 40 in FIG. 2) for the information processing described elsewhere herein.

In one implementation, the image collection process described above can be accomplished while the tracking vehicle 80 is pushing/pulling carts (not shown) around the facility. As such, the image collection process can take place while the tracking vehicle 80 is being used to transport items to various areas or retrieve items from various areas, thereby resulting in a dual-functionality for the vehicle 80 in which both functions can be performed at the same time. Alternatively, the tracking vehicle 80 can be programmed or operated to perform solely the image collection process, including, for example, performing the process at any time during the day when the vehicle 80 is not being used to transport carts containing items or at any time at night while the facility is generally empty of people and there is no item transportation taking place.

According to one embodiment, the image collection process can be performed as an ongoing, day-to-day process that confirms or updates the location of each item in the facility (and other information about the item) while the tracking vehicle (such as vehicle 80) performs its cart/item transportation functions within the facility. Alternatively, the vehicle can be used solely for the image collection process and location tracking at any given time during the day or night, as discussed above. In a further alternative, the tracking vehicle can be operated to perform the image collection process as part of an audit of the facility. That is, the image collection that includes location information for each item can be stored and used as visual evidence of the location of the item within the facility, thereby eliminating the need for audit personnel to physically walk through the entire facility and physically identify every single item therein. Instead, the images with location information can be stored and used as evidence of the physical location of the item.

The various embodiments of tracking vehicles and systems disclosed or contemplated herein can also have a real-time alarm functionality that alerts a user about important item information at the time the information is collected. For example, if a user at a facility is attempting to find a specific item, the user can enter the information about that item and/or its barcode into the system, thereby creating an alarm that causes the system to trigger an alert to the user (transmitted to the user's computer, smartphone, or other device) when that barcode (and location thereof) is identified by the system during the image collection process.

As such, according to certain embodiments, the system and vehicle embodiments disclosed or contemplated herein provide accurate tracking of items and empty spaces in a facility. That is, the system, device, and method embodiments provide for tracking the physical location of and any movement of an item, such that all items at a particular location can be monitored such that movement of any existing item from one location to another within the facility or out of that facility or any importation of a new item into the facility can be monitored. Further, the various embodiments can be used to identify empty spaces in the facility, thereby providing useful information about available space for further items or about potentially missing items that were expected to be located in those spaces. According to another embodiment as described in further detail above, the discovery of an item at a new or different location can trigger the system to transmit a message or electronic alert in any form to an appropriate user. The message or alert can prompt the user to confirm that the location of the item is authorized. In a further alternative, the message can provide any appropriate information relating to the item and/or its transport.

The tracking vehicle, according to any embodiment herein, can utilize and provide certain information relating to the barcodes (and thus items to which the barcodes are attached) without utilizing its connection to the central processor of the system. More specifically, the vehicle can provide automatic alarms or notifications that are triggered at the vehicle, not at the central processor or any other part of the system. According to one embodiment, the vehicle 42 in FIG. 2 (or any other vehicle embodiment herein) has an automatic alarm component (not shown). For example, in one embodiment, when an item is identified as being located in an unauthorized or unexpected location as a result of the image of the item (or barcode thereof) being captured and processed, an audio and/or visual alarm associated with the vehicle is triggered by the vehicle. This occurs because (1) the barcode associated with the item includes information that the item is in the wrong location, (2) the barcode was previously identified by a user as a barcode of interest, (3) the “empty barcode” or other indication that a space is empty indicates that an item is missing, or (4) any other reason that it is desirable to trigger an alarm in real-time relating to an item, and the camera captures the information on the barcode, the image is processed and the alarm is automatically triggered by the processor based on that information and the location. Alternatively, any information can be included in the barcode that can trigger an automatic alarm or any other known action at a vehicle for any known purpose.

The systems, methods, and devices disclosed or contemplated herein allow for highly accurate inventory tracking, including, for example, tracking unauthorized movement of items within a facility, the loss of such items, the absence of items from their expected locations, or the availability of empty spaces. In one embodiment, a barcode or other information summary can be associated with an item (that is, the asset can be “tagged”) by a manufacturer or supplier prior to delivering the item to the facility. Alternatively, the barcode or information summary can be added to the item at the facility.

In addition, the various systems, methods, and devices herein can also be used to track, maintain, and/or adjust inventory levels at a facility. Further, the various embodiments can also create an alarm, alert, or communication to be transmitted to a user when the inventory level for a particular item drops below a predetermined level or the number of empty spaces rises above a predetermined level. For example, if a predetermined minimum level of item A in the facility is set at 50 items, and the tracking process as described according to any embodiment herein identifies 49 or fewer of item A, then the alarm is transmitted.

According to other implementations such as that shown in FIG. 5, a system 110 is provided that includes an autonomous, multifunctional system 112 that can be used to perform various different functions in a building setting and collect data relating to those functions. More specifically, as discussed above, the system 110 can be used to stock items in the building, detect and track the presence of items within the building (in a fashion similar to that described above with respect to the tracking vehicle and system embodiments), and/or perform disinfection of target areas of the building using ultraviolet light. In certain embodiments, the autonomous system 112 includes an autonomous self-propelled vehicle 122 and at least one attachable cart 124 as shown, wherein each the cart 124 can be a multi-functional cart 124 or, alternatively, an interchangeable cart 124 that is designed to perform one or more of the various functions.

The various multi-functional system embodiments disclosed or contemplated herein (including the system 112 and the various cart embodiments discussed herein) can be configured to utilize a multi-functional cart that supports the various different functions/activities by having the required sensors or cameras or other equipment for those functions/activities incorporated into or removably added to the cart. Such a multi-functional cart, along with various interchangeable cart embodiments, will be described in further detail below.

The network-based system 110 of FIG. 5 is just one example of a system 110 for operating an autonomous mobile system 112 to stock items, track items, and/or disinfect a specific area of a building/facility. This specific embodiment as shown is substantially similar to the system 40 described above with respect to FIG. 2 except with respect to the differences specified herein. That is, the system 110 also has a server 116 in communication with an autonomous system 112 (including an autonomous powered vehicle 122 and an attachable cart 124) according to any implementation herein and client computers 120 through a network 114. The characteristics and functionality of the similar components (including the client computers 120, the network 114, the server 116, and the database 118) and the operation thereof are substantially the same as the corresponding components as described above with respect to the system 40, except as discussed herein. The system 110 allows for one or more of the following operations: stocking, tracking, and/or managing items at a facility (such as goods at a warehouse, products in a retail establishment, or any other known items at any type of facility that can benefit from stocking, tracking, and/or an audit of such items) and further for disinfecting such a facility. It is understood that the network 114 can be a wireless communication network 114 such that the autonomous mobile system 112 (and any on-board processor(s) on the system 112 as discussed elsewhere herein) is in communication with the server 116 via the wireless network 114.

According to one embodiment, the database 118 can contain information regarding each item to be stocked and/or tracked, such as item identification, description, location in the facility, base cost, historical maintenance and service information (where appropriate), or any other kind of information relating to the item. In addition, the database 118 can contain information regarding the disinfection of the facility, including, for example, the duration of the application of the disinfecting UV light, the intensity of the light, and the time that the disinfection took place. Further, it is understood that the database 118 can also include any other known type of information relating to the item, the disinfection, and/or the facility. Alternatively, various embodiments of the system described herein can have separate databases for various different kinds of information, including the information discussed herein.

It is understood that any embodiment of the systems 110 disclosed herein that provide for the functions described herein can be controlled using software associated with the system. It is further understood that the software in the central processor 116 can be any known software for use with the systems described herein to operate one or more mobile autonomous systems to stock, track, and manage items, disinfect target areas, and process information as described herein.

In the system 110, generally, stocking, item, inventory, and disinfection data, including various types of data as discussed elsewhere herein or as is understood in the art, can be entered into the system 110 via the autonomous mobile system 112 and/or a client computer or processor 120 such that the data is received by the server 116 and stored in the database 118.

The mobile autonomous system 112, according to one implementation, is a combination of an autonomous powered vehicle (also referred to as an “autonomous prime mover”) 122 and at least one attachable, interchangeable cart 124 that can be attached to and can be transported to any desired location within the facility by the powered vehicle 122. Embodiments of the powered vehicle 122 and the interchangeable carts 124 will be described in additional detail below.

One exemplary autonomous powered vehicle 130 is depicted in FIGS. 6A-6C. The vehicle 130 has a body 131, a deployable base 132 attached to the base 131 and on which a user/operator can stand, wings (or “arms”) 134 extending proximally from the body 131, wheels 136 rotatably coupled to the body 131 and the wings 134 as shown, and an optional steering wheel 138 for a operator to use when the vehicle 130 is in the non-autonomous mode. In addition, the vehicle 130 has a hitch 140 to which the attachable carts discussed elsewhere herein can be removably attached.

Alternatively, the various system embodiments disclosed or contemplated herein can utilize any known autonomous or manually-controlled powered vehicle 122, including the apparatus that can transport carts or other types of trailers as disclosed in the '771 Patent, which is incorporated above. In an alternative specific example, the powered vehicle 122 is an autonomous version of the apparatus of the '771 Patent. In a further alternative, the powered vehicle 122 can be any known self-propelled or manually-propelled vehicle—and can either be autonomously or manually controlled—that can move about and operate in a facility of interest. Regardless of the vehicle 122, it is understood that the vehicle 122 can be attachable to any of the attachable carts disclosed or contemplated herein such that the vehicle can transport such carts around the target facility/building.

In certain embodiments of the system 110, the powered vehicle 122 (including vehicle 130) can have an on-board processor and software similar to the processor 116 and software described above. Alternatively, the information capturing and processing software as described elsewhere herein can be disposed on the server 116. In a further alternative, the software can be disposed on both the on-board processor and on the server 116.

The various cart embodiments will now be discussed in additional detail, including both the multifunctional cart implementations and the interchangeable cart implementations.

In one example, a basic configurable, multifunctional cart 150 according to one specific, non-limiting embodiment is depicted in FIGS. 7A-7D. The cart 150 has a base 152, wheels 154 rotatably attached to the base 152, a battery 156 (as best shown in FIGS. 7C and 7D), a processor 158 (as best shown in FIGS. 7B and 7C), a hitch 160 for attachment to a powered vehicle (such as the vehicles discussed elsewhere herein) (as best shown in FIGS. 7B and 7C), and a user interface 162 (as best shown in FIGS. 7A and 7D) coupled to the processor 158 for controlling the cart 150 and/or the information collection related thereto. It is understood that the cart 150 can also have various other components thereon depending on the desired functionality. For example, in one embodiment, the cart 150 can also have a collection apparatus (not shown) substantially similar to the various collection apparatuses (such as, for example, collection apparatus 8 discussed above) disclosed or contemplated elsewhere herein. The user interface 162 (which can be, for example, a touchscreen pad 162) can be used by an operator to communicate with the processor 158 and/or the full system 110. The battery 156 is coupled to the other components such that the battery 156 provides power thereto. In addition, motors (not shown) are provided that are coupled to the various other possible components (such as, for example, the collection apparatus—not shown—discussed above) to operate those various components and any other moving parts thereof.

The on-board processor 158 is coupled to the server of the overall system (such as server 116 discussed above with respect to FIG. 5) via a wireless connection such that any information collected via the processor 158 can be transmitted or otherwise transferred to the server. The information collected by the processor 158 can include any information initially collected via the interface 162 and/or any sensors or data collectors (not shown) of any kind on the cart 150, depending on the variable configuration of the cart 150 as discussed in additional detail below. Further, it is understood that any information collected at the cart 150 in any way or via any device/component disclosed or contemplated herein is transferred to the on-board processor 158 and/or to the server (such as server 116) in any known fashion such that software can process the information and then store that information as described elsewhere herein.

As mentioned above, in certain embodiments, the cart 150 can have a collection apparatus (not shown) that is coupled to the processor 158 in a fashion similar to the processor 30 as discussed in detail above and can function in a similar fashion to process the electronic information captured by the cameras (not shown) and/or the reader (not shown) of the collection apparatus (not shown) and process the information to identify the information captured on the target items. As such, the cameras and the reader (not shown) function to capture information/images in the fashion described above, including item information, barcode information, and/or empty space information, for example. It is understood that the collection apparatus (not shown) can have components that are similar to corresponding components in the apparatus 8 above and have substantially similar functions and features. For example, the collection apparatus (not shown) can have at least one digital camera and at least one RFID reader (not shown) both attached to an extendable mast (not shown). The features and functionality of those components are substantially similar to those discussed above and are also non-limiting in the same fashion as those components (various other configurations are contemplated).

As shown, it is understood that the basic configurable multifunctional cart 150 embodiment as shown has fundamental components necessary for operation of the cart 150 regardless of the desired configuration and/or functionality. That is, the processor 158, interface 162 and other components are found in every version of the cart 150 and operate in conjunction with the other configurable components that can be removably attached or incorporated into the cart 150. For example, the cart 150 in various configurations can have one or more temperature sensors, location sensors, speed sensors, cameras, other sensors/data collection devices, lights, etc.

Another embodiment of the cart 150 is depicted in FIGS. 8A and 8B, in which the cart 150 has a removable, adjustable scaffold (or “frames”) 170 that can be attached to the cart 150 to receive various components for use with the cart 150, including any of the sensors or other components discussed elsewhere herein. The scaffold 170 in this specific, non-limiting embodiment has first and second vertical legs (or vertical “bars” or “tubes” or “elongate structures”) 172A, 172B that can hold one or more detachable horizontal arms (or horizontal “bars” or “tubes” or “elongate structures”) 174, 176 that can be attached at various locations along the height of the legs 172A, 172B. It is further understood that is it also possible to provide other structures that are attachable to the scaffold 170, including one or more bars (not shown) that extend between the two of the arms (such as arms 174, 176) and/or bars (not shown) that extend between two scaffolds (not shown) removably attached to the cart 150. In one embodiment, the cart base 152 has sockets (or “female connectors”) 178 disposed on or otherwise attached to the base 152 such that one or more scaffolds 170 can be attached to the base 152 via the sockets 178. In one embodiment, the cart 150 has four sockets 178, with one disposed in each corner of the base 152. Alternatively, the base 152 can have two, three, five, or any number of sockets 178 depending on the number and configuration of the scaffolds that can be attached thereto. In a further alternative as best shown in FIGS. 9A-9C and discussed in detail below, one of the legs of the scaffold 170, instead of being coupled or otherwise attached to the base 152, can have a wheel disposed on the end such that the wheel can be in contact with the surface on which the cart 150 is disposed. It is understood that any of the various components for the configurable cart embodiments herein can be disposed on, removably attached to, integral with, or otherwise associated with any portion of the scaffold(s) 170 (including either or both of the legs 172, 172B and the arms 174, 176) as needed to perform the desired functionality.

Various sensors and other instruments can be removably attached to the horizontal elongate structure 174 or the vertical elongate structures 172A, 172B such that the selected instruments can perform the desired function depending on the specific purpose of the configuration, as discussed elsewhere herein. In other words, depending on the desired functionality/activity (such as security, disinfection, item tracking, and any other functionality/activity as discussed elsewhere herein), the appropriate instruments/devices can be attached to the scaffold(s) 170 to perform that desired activity. For example, the instruments can include, but are not limited to, shelf-scanning and/or inventory cameras, cameras and/or sensors for detecting slip and fall situations, UV light for disinfection (including lights directed downward to disinfect the floor and/or lights directed outward/horizontally to disinfect adjacent shelves/objects), temperature sensors, security cameras, a barcode reader, an RFID reader, and/or any other known sensor, detection device, or instrument for collecting information in a large area or retail or warehouse setting.

In one exemplary implementation, the configurable multifunctional cart 150 can be configured to disinfect a large area/building, as depicted in FIGS. 9A-9C, according to one exemplary, non-limiting embodiment. In addition to the structures, components, and features of the basic cart 150 as discussed in further detail above (and will not be discussed in detail with respect to this embodiment except to the extent that any of those components differ), the cart 150 has two removable scaffolds 190, 192 removably attached to the base 152 The first scaffold 190 in this specific, non-limiting embodiment has first and second legs 194A, 194B that has two detachable arms 196A, 196B that can be attached at various locations along the height of the legs 194A, 194B. The first leg 194A is removably attached to the base 152 at a socket 178, while the second leg 194B has a wheel 200 disposed at its distal end. The second leg 194B is longer than the first leg 194A such that the wheel 200 of the second leg 194B is disposed at substantially the same horizontal height as the wheels 154 of the cart 150 such that the wheel 200 is in contact with and is rollable along the same surface that the cart 150 is disposed on. As such, the wheel 200 and the leg 194B provide additional support and stability to the scaffold 190 and the cart 150 as a whole to help prevent the cart 150 from tipping over as a result of being “top heavy.” Similarly, the second scaffold 192 has first and second legs 210A, 210B that has two detachable arms 212A, 212B that can be attached at various locations along the height of the legs 210A, 210B. The first leg 210A is removably attached to the base 152 at a socket (not shown), while the second leg 210B has a wheel 216 disposed at its distal end. The second leg 210B is longer than the first leg 210A such that the wheel 216 of the second leg 210B is disposed at substantially the same horizontal height as the wheels 154 of the cart 150 such that the wheel 216 is in contact with and is rollable along the same surface that the cart 150 is disposed on. As such, the wheel 216 and the leg 210B provide additional support and stability to the scaffold 192 and the cart 150 as a whole to help prevent the cart 150 from tipping over as a result of being “top heavy.”

In addition, in this specific implementation, the scaffold 190 also has an additional attachable vertical elongate structure (or “bar”) 220 that is attached at one end to the first arm 196A and at the other end to the second arm 196B as shown. As best shown in FIG. 9B, the attachable bar 220 in this embodiment is a sensory array bar 220 that can have one or more instruments or devices attached to or otherwise disposed on the bar 220. In this specific example, the bar 220 has a camera 222, an RFID reader 224, a temperature sensor 226, a UV light array 228, and a floor-scanning camera 230. Alternatively, any configuration of instruments can be incorporated into or disposed on the bar 220, so long as, for purposes of the disinfection cart configuration, it includes at least one UV light on the bar 220 or elsewhere on at least one of the scaffolds 190, 192.

Further, this exemplary embodiment also includes a deployable arm 240 rotatably attached to the scaffold 192. More specifically, the arm 240 is rotatably attached to the first leg 210A such that the deployable arm 240 can rotate around the longitudinal axis of the leg 210A as shown in FIGS. 9A and 9C. In one implementation, the arm 240 can rotate between a retracted position in which the distal end of the arm is attached or otherwise coupled to the leg 210B and an extended or deployed position in which the arm 240 rotates away from the cart 150. FIG. 9C depicts the deployable arm 240 disposed in a position between the retracted position and the deployed position. At the distal end of the arm 240 is a UV light array 242. The UV light array 242 is attached to the deployable arm 242 such that the lights in the array 242 are directed away from the cart 150. According to one embodiment, the light array 242 can have shields (not shown) disposed on both sides of the array 242 such that the shields (not shown) direct or “focus” the light emitted therefrom in the desired direction.

In accordance with certain implementations, as best shown in FIG. 9C, the scaffold 192 also has an actuator (typically a motor) 244 that is coupled to the leg 210A and/or the deployable arm 240 such that the actuator 244 provides the force to move the arm 240 between its retracted and extended positions. In addition, the arm 240 can have a proximity sensor 246 disposed at or near the distal end of the arm 240 such that the sensor 246 can be used to detect when the arm 240 is approaching an object while being urged toward its extended position.

In accordance with certain implementations, the deployable arm 240 also has a vertical extension feature such that the arm 240 can also be actuated between a lowered and a raised position (not shown) such that the light array 242 can be positioned at a greater height to disinfect the target surfaces/objects disposed at a greater height than the physical height of the unextended arm 240 on the cart 150.

Similarly, according to certain embodiments, there are UV lights disposed on the underside along the length of the arm 240 and further can be disposed on the underside of the base 152 (with appropriate shields (not shown) in certain implementations) that are directed downward toward the floor to disinfect the floor over which the cart 150 passes. In addition, UV lights can also be provided on a top side of the arm 240 and/or other top surfaces of the cart 150 and/or scaffolds 190, 192 to emit the UV light upward to reduce or eliminate airborne pathogens in the ambient air above the cart 150.

Further, in accordance with various alternative implementations, the rotatable arm 240 can also be extendable. That is, the rotatable arm 240 can have an extendable section that can be urged between a retracted position and an extended position by the actuator 244 or a separate actuator (not shown).

Further, it is understood that, in accordance with certain embodiments, the scaffold 190 can also have a deployable arm (like arm 240) and the various additional features and components as described herein. In a further alternative, it is also understood that the scaffold 192 can also have an attachable bar similar to bar 220. It is further understood that either or both of the scaffolds 190, 192 can be coupled at both legs 194A, 194B, 210A, 210B to the base 152 via sockets 178 and not have any wheels disposed on the distal ends thereof.

The on-board processor 156 is coupled to the arm 240 and the light array 242 such that the processor 156 (or the server 116, or both) can communicate with and control the arm 240 and light array 242 to operate in the fashion described herein. Further, the processor 156 and/or the server 116 can collect information about the cart 150 and the components thereof during operation, including the time at which a particular location is disinfected, the speed of the cart 150 at any given time, the intensity of the lights in the light array 242 (or elsewhere on the cart 150), the position of the arm 240, and any other relevant information relating to the operation of the cart 150 and the disinfection of the desired area. Thus, the collected information can be used to confirm the successful disinfection of the area(s) covered by the cart 150 during any period of operation. More specifically, the information is transported to the on-board processor 156 and/or to the server 116 such that software can process the information to determine whether disinfection of a specific area was successful and then store that information in the database 118 in a fashion similar to that described in other embodiments above.

In one embodiment, the lights in the array 242 (and any other lights on the cart 150) emit ultraviolet (“UV”) light. In certain more specific implementations, the lights emit UV-C light, which has a wavelength ranging from 100 to 280 nm. Alternatively, the lights can emit any known light that can disinfect objects and/or the ambient air.

In use, the configurable cart 150 that is configured as a disinfection cart 150 as shown in FIGS. 9A-9C can be attached to an autonomous powered vehicle (such as vehicle 130, for example) and transported along the aisles of the facility. More specifically, the desired route can be inputted into the processor (not shown) of the autonomous vehicle. Once the vehicle is ready to proceed, the processor (not shown) of the vehicle 130 can communicate with the processor 156 of the cart 150 (either directly or via the system 110) to actuate and coordinate the operation of the disinfection cart 150 (and the arm 240 and lights) during transport of the cart 150 along the desired route. As such, the combination of the vehicle and the cart 150 can operate to disinfect the target areas.

When the cart 150 is disposed in the desired location in the target aisle(s), the deployable arm 240 (or arms) is actuated (by the processor 156 transmitting signals to the actuator 244 to move into its deployed position as best shown in FIG. 9C. The arm 240 extends out until it is within a predetermined distance from the shelves (or doors, or any other objects that define the borders of the aisle). At that point, the proximity sensors 246 disposed on the distal end of the arm 240 detect that the arm 240 is disposed within a predetermined distance from the border of the aisle (or other object) and transmit that information to the processor 156 such that the processor 156 transmits instructions to stop the further extension of the arm 240. It is understood that any predetermined distance can be inputted into the processor 156 for purposes of positioning of the distal end of the arm 240 in relation to the shelves or other objects.

In addition, the lights on the array 242 and elsewhere are actuated by the processor 156 at the appropriate time as well. In one embodiment, the lights are actuated as soon as the cart 150 begins to move. Alternatively, the lights can be actuated once the arm 240 is deployed as desired. In a further alternative, the lights can be actuated at any desirable point during operation.

With a given UV light bulb output, it is understood that the required disinfection dose is directly related to the distance of the bulb from the target surface and duration of the light being applied to that surface. For example, according to one embodiment, a 300 watt bulb can disinfect all or almost all of a surface positioned between about 6 and about 12 inches from the bulb while the bulb (the cart 180) is traveling at a rate of 1 foot per second. It is understood that any of these variables can be adjusted based on the adjustment of the other variables to achieve an equivalent level of success with respect to disinfection. The software in the processor 156 and/or the server 116 can be used to determine the optimal speed for the cart 150 based on the bulb intensity and the distance from the target surface. Further, if either the distance or the bulb intensity changes for some reason, the software can be used to adjust the speed of the cart 150 accordingly. Further, because the cart 150 location is tracked (along with the speed), the software can also be used to confirm or “certify” that a specific location, aisle, or area has been disinfected successfully and provide a time stamp for that disinfection. In addition, the software can also utilize that information in combination with a facility map or layout to generate a report to an operator or facility employee regarding the disinfection status. Further, any of this information or any other information relating to tracking as discussed above can be compiled, processed, and provided in reports generated by the system 110.

Another activity for which the configurable cart 150 (such as the cart 150 of FIGS. 8A and 8B) can be configured is inventory stocking. Thus, the configurable cart 150 of FIGS. 8A and 8B becomes a stocking cart 150. Alternatively, in those embodiments in which the carts are non-configurable and have predetermined and permanent functionality, the attachable cart that can be included in the fleet of carts is a stocking cart (similar to cart 150 in FIGS. 8A and 8B). A stocking cart can simply be a flatbed cart for carrying items to be stocked at or otherwise moved around the facility. In one implementation, the cart 150 of FIGS. 8A and 8B can be the stocking cart 150, with the base 152 serving as the flatbed. In operation, an operator can program or otherwise instruct the autonomous vehicle (such as vehicle 130) to travel along a specific route to transport the stocking cart 150 with specific items disposed on the base 152 to a specific location or series of locations. As such, the items on the cart 150 can be transported to the desired location and then removed from the cart 150 and stocked as desired. In certain implementations, the autonomous vehicle can also autonomously or automatically unhitch from the cart 150 at the desired location such that the cart 150 is left at the desired location and the vehicle then travels to another location or back to the loading dock or other loading location. In further embodiments, the vehicle can be programmed to retrieve an empty cart 150 from the facility floor and transport it back to the loading area.

In another embodiment, the cart 150 of FIGS. 8A and 8B can be used as an item tracking cart 150. That is, the cart 150 can have one or two scaffolds (like scaffold 170) with a collection apparatus (similar to collection apparatus 8) disposed on one or both of such scaffolds. The collection apparatus can have substantially the same components and operate in substantially the same fashion as the apparatus 8 discussed above. As such, the cart 150 can be operated in a fashion similar to the tracking vehicle embodiments discussed above. More specifically, an operator can input a desired route into the autonomous vehicle (such as vehicle 130). Once the vehicle is ready to proceed, the processor (not shown) of the vehicle 130 can communicate with the processor 156 of the cart 150 (either directly or via the system 110) to actuate and coordinate the operation of the collection apparatus during transport of the cart 150 along the desired route. As such, the combination of the vehicle and the cart 150 can operate in a fashion similar to the tracking vehicle embodiments discussed in further detail above.

It is understood that the various embodiments herein can include methods and systems for utilizing a single autonomous vehicle with either a single configurable cart (such as cart 150 of FIGS. 8A-8B) or two or more interchangeable attachable carts such that the interchangeable cart can be selected based on the desired functionality. Thus, after hours, the autonomous vehicle can be attached to a disinfection cart (such as configurable cart 150 as configured in FIGS. 9A and 9C) and instructed to transport the cart in a coverage pattern that causes it to move through and disinfect all the aisles of the facility overnight. Alternatively, on nights when sterilization is unnecessary, the autonomous vehicle can be attached to a tracking cart (such as configurable cart 150 configured for tracking as described above, for example) and instructed to move through the facility in a coverage pattern such that it can detect, identify, and track each item therein in a fashion similar to that described elsewhere above. In a further alternative, either of these procedures can be performed during normal business hours as needed or as possible. Yet another alternative involves attaching the autonomous vehicle to a configurable cart configured as a stocking cart (or an interchangeable stocking cart) to transport items from an exterior location (such as a loading dock) to the location where the item is to be placed within the facility. It is further understood that the fleet of vehicles and carts can include at least two autonomous vehicles and at least one configurable cart or at least three interchangeable carts (at least one each of a tracking cart, a disinfection cart, and a stocking cart) for each such vehicle. Alternatively, any number of autonomous vehicles and carts can be provided.

In certain alternative embodiments, the one or more autonomous vehicle has the tracking, transporting, and/or sterilization features built into the vehicle such that the attachable carts are unnecessary. In another alternative, one attachable or configurable cart can incorporate at least two of the stocking, tracking, and/or sterilization components/features thereon. For example, a combination tracking and disinfection cart could perform both functions at the same time. Alternatively, any combination of stocking, tracking, and/or disinfection could be provided in any cart to create double or triple purpose while reducing time requirements.

The various embodiments herein can be incorporated into a single robotic platform in which a single robotic guidance system (an autonomous vehicle according to any of the embodiments herein) can be “shared” by one or multiple cart configurations that meet the specific needs of the user in a large space. Such a robotic platform can be leveraged in many ways to perform multiple different activities.

In one non-limiting example, an autonomous vehicle can be coupled to an inventory stocking cart (or the configurable cart configured as such) and used in the location from, for example, 5 AM to 9 AM to deliver inventory for restocking. After 9 AM, the autonomous vehicle can be coupled to a tracking cart (or the configurable cart can be configured as a tracking cart) and travel a specified route to take inventory of the space or track the objects on the shelves. Alternatively, or later, the autonomous vehicle can be coupled to a cart for scanning aisles for slip and fall situations or cleanliness (or the cart 150 can be configured as such) and travel a specified route. Alternatively, the cart 150 can be configured to perform all three activities. And in this example, after 9 pm, the autonomous vehicle can be coupled to a disinfection cart (or the configurable cart can be configured as a disinfection cart) and travel a specified route to disinfect the space.

Alternatively, the cart 150 can be configured to perform any of the functions described elsewhere herein, including completing temperature checks or other tasks, simply by adding the required sensors, cameras, lights, or other instruments.

With respect to any of the embodiments or activities disclosed or contemplated herein, the information collected can be both stored onboard (in the processor 156, for example, or some onboard database coupled thereto) and/or communicated via a network (such as network 114) (via wifi or cellular communications or any other wireless technology) to a database (such as database 118) where the information can be analyzed and reported. As mentioned above, any cart (such as cart 150) herein can be configured with sensors to collect information about the cart's location, speed, and with timestamps, automate the tracking, verification, and reporting of these activities. For example, the tracking and reporting of disinfection is described in further detail above.

As such, the various system embodiments herein provide for the ability to robotically complete multiple critical tasks to maintain the health and safety of an environment. Those tasks are monitored, tracked, and reported using the onboard computer and communications system. That system enables near real-time reporting capabilities for a single or multiple tasks, including reporting such information to a single dashboard.

Although the various embodiments have been described with reference to preferred implementations, persons skilled in the art will recognize that changes may be made in form and detail without departing from the spirit and scope thereof.

What is claimed is:

1. A multifunctional area management system, the system comprising:
(a) an information management system comprising:
(i) a central processor accessible on a wireless network;
(ii) a database in communication with the central processor, the database comprising area management information stored within the database;
(b) an autonomous prime mover; and
(c) at least one configurable cart comprising:
(i) a base comprising:
(A) wheels operably coupled to the base; and
(B) a hitch operably coupled to the base, wherein the hitch is coupleable with the autonomous prime mover;
(ii) an onboard processor associated with the base, wherein the onboard processor is in communication with the central processor;
(iii) an interface associated with the base, wherein the interface is in communication with the onboard processor;
(iv) at least one removable scaffold coupleable with the base, the at least one removable scaffold comprising at least one leg and at least one horizontal structure coupled to the at least one leg; and
(v) at least one area management instrument removably coupled to the at least one removable scaffold.

2. The multifunctional area management system of claim 1, wherein the at least one area management instrument comprises a camera; a temperature sensor, an RFID reader, a barcode reader, a UV light array; a location sensor, or a speed sensor.

3. The multifunctional area management system of claim 2, wherein the camera comprises an object identification camera, a security camera, or a slip-and-fall danger detection camera.

4. The multifunctional area management system of claim 1, wherein the at least one configurable cart is a inventory tracking cart, a disinfection cart, an item stocking cart, or a spill detection cart.

5. The multifunctional area management system of claim 1, wherein the at least one leg comprises first and second legs, wherein the at least one horizontal structure comprises first and second horizontal structures coupled at a first end to the first leg and at a second end to a second leg.

6. The multifunctional area management system of claim 5, further comprising at least one attachable bar coupled at a first end to the first horizontal structure and at a second end to the second horizontal structure.

7. The multifunctional area management system of claim 6, wherein the at least one area management instrument is removably coupled to the attachable bar.

8. The multifunctional area management system of claim 1, further comprising at least one attachment component associated with the base, wherein the at least one removable scaffold is coupleable with the base via the at least one attachment component.

9. The multifunctional area management system of claim 8, wherein the at least one attachment component comprises a socket.

10. The multifunctional area management system of claim 1, wherein the at least one removable scaffold is a disinfection scaffold comprising:
(a) the at least one leg comprising first and second legs;
(b) the at least one horizontal structure comprising first and second horizontal structures, wherein each of the first and second horizontal structures is coupled at a first end to the first leg and at a second end to the second leg;
(c) a UV light array removably coupled to the disinfection scaffold.

11. The multifunctional area management system of claim 10, wherein the disinfection scaffold comprises first and second disinfection scaffolds.

12. The multifunctional area management system of claim 1, wherein the at least one removable scaffold is an object tracking scaffold comprising:
(a) the at least one leg being an extendable leg; and
(b) a collection apparatus removably coupled to the scaffold.

13. The multifunctional area management system of claim 12, wherein the collection apparatus comprises at least one camera and at least one RFID reader.

14. A configurable, multifunctional area management cart comprising:
(a) a base comprising:
(i) wheels operably coupled to the base; and
(ii) a hitch operably coupled to the base, wherein the hitch is coupleable with an autonomous prime mover;
(b) an onboard processor associated with the base, wherein the onboard processor is in communication with a central processor on a network;
(c) an interface associated with the base, wherein the interface is in communication with the onboard processor;
(d) at least one removable scaffold coupleable with the base, the at least one removable scaffold comprising:
(i) first and second legs, wherein at least one of the legs is removably coupleable with the base;
(ii) first and second horizontal structures, where each of the first and second horizontal structures is coupled at a first end to the first leg and at a second end to the second leg;
(e) at least one area management instrument removably coupled to the at least one removable scaffold, wherein the at least one area management instrument comprises a camera; a temperature sensor, an RFID reader, a barcode reader, a UV light array; a location sensor, or a speed sensor.

15. The configurable, multifunctional area management cart of claim 14, wherein the camera comprises an object identification camera, a security camera, or a slip-and-fall danger detection camera.

16. The configurable, multifunctional area management cart of claim 14, further comprising at least one attachment component associated with the base, wherein the at least one removable scaffold is coupleable with the base via the at least one attachment component.

17. The configurable, multifunctional area management cart of claim 14, wherein the at least one removable scaffold is a disinfection scaffold comprises first and second disinfection scaffolds, wherein each of the first and second disinfection scaffolds comprise at least one of the UV light array removably coupled thereto.

18. The configurable, multifunctional area management cart of claim 14, wherein the at least one removable scaffold is an object tracking scaffold comprising:
(a) the at least one leg being an extendable leg; and
(b) a collection apparatus removably coupled to the scaffold, wherein the collection apparatus comprises the camera and the RFID reader.
